(19) United States
(12) Patent Application Publication
(10) Pub. No.: US 2024/0221143 A1
(43) Pub. Date: Jul. 4, 2024

(54) METHODS AND SYSTEMS FOR THE AUTOMATIC QUALITY INSPECTION OF MATERIALS USING INFRARED RADIATION

(71) Applicant: AUTAZA TECNOLOGIA S.A., São José dos Campos (BR)

(72) Inventors: Renan Padovani, São José dos Campos (BR); Enivaldo Amaral de Souza, Jacareí (BR); Donizete Lucio de Campos, São José dos Campos (BR)

(21) Appl. No.: 18/542,086

(22) Filed: Dec. 15, 2023

(30) Foreign Application Priority Data
Dec. 15, 2022 (BR) 10 2022 025677 2

(51) Int. Cl. G06T 7/00; G01N 1/44; G01N 21/88; H04N 23/20; H04N 23/56

(52) U.S. Cl. CPC G06T 7/0004; G01N 1/44; G01N 21/8851; H04N 23/20; H04N 23/56; G06T 2207/10048; G06T 2207/20084; G06T 2207/30136

(57) ABSTRACT

Methods and systems for automatic quality inspection of materials using radiation emitted in the infrared spectrum are described. According to the method of the invention, a radiation pattern falls on a material to be analyzed, the reflected image is captured by a capture device and a defect in the material is detected by the distortion it causes in the pattern included in the captured image. Finally, a software locates, identifies and classifies such distortions and, consequently, the defects of the inspected material, by artificial intelligence techniques.

### TECHNICAL FIELD

The present invention relates to methods and systems for the automatic quality inspection of materials. The methods and systems described herein can be used in the quality inspection of a wide variety of products, for example, metallic, plastic, resin, composite, glass, crystal, or mixtures thereof, molds and various tooling, including stamping, injection, fiber application, resin, composite manufacturing, packaging, glass or crystal fabrication. The methods and systems described herein can be used in the quality inspection of vehicles, such as bicycles, motor vehicles (motorcycles, cars, vans, buses, trucks, road implements, tractors, excavators, forklifts, agricultural machinery), rail vehicles (trains, trams), vessels (boats, motorboats, yachts, ships), amphibious vehicles (screw-propelled vehicles, airboats, hovercraft), aircraft (airplanes, helicopters, aerial vehicles Unmanned, eVTOL), rockets and spacecraft. The methods and systems described herein can be used in the quality inspection of consumer goods such as refrigerators, freezers, air conditioners, washing machines, dishwashers, dryers, microwave ovens, stoves, computers, and telephones.

### BACKGROUND

In a motor vehicle or consumer goods industry, various transformations are carried out, such as cutting, bending, drilling, assembling and painting. With each transformation that is performed, it is common to verify that the transformation has been performed correctly.

The manufacture of an automobile in the industry has as main stages: stamping of metal sheets of the body, welding of the body, painting, and assembly of auto parts.

In the stamping process, flat steel sheets of just under 1 millimeter thickness are formed in three or four presses, each containing a lower (die) and an upper (punch) tooling. The punch exerts a force of several tons on the workpiece in its descent, performing a function of mechanical forming, pulling, cutting or bending, so that at the end of the sequence of operations, a new body part is produced. Most automobiles have a metal body composed of low-carbon steel (CR4), although some higher-value-added automobiles may be built of aluminum.

In the welding process, the metal sheets are joined together in a body using welding robots. Automotive paint is the coating with an approximate thickness of 0.1 millimeters to which the metal body is subjected, with layers of Phosphate, Electroplating, Primer, Base Paint and Varnish, and has the objective of aesthetics and protection against corrosion. The body of the car moves around the factory supported by a skid, a metal structure with casters that moves on rails. Hundreds of auto parts are mounted on the vehicle, such as wiring, dashboard, seats, windows, engine, suspension, wheels, and tires.

After each stage of transformation, a quality control is carried out to ensure that the parts have been correctly manufactured, with the aim of ensuring the perfect coupling between the parts to assemble the product, the functionality of the product and a high-quality finish of the body that satisfies customer expectations. After stamping the parts, the metal parts are checked for problems caused during the stamping process. After welding, a check is made of the car body for surface defects such as positive mark, negative mark, lift, sinking, buckling, ripple or wrinkles. During these stages of production, irregularities in the surface of the body often go unnoticed by the human eye, due to the matte characteristics of the unpainted metal. These same ripples with millimeter depth, however, become visible and disturbing when automotive parts are painted and become mirrored.

In the invention described here, the focus is not on the dimensional inspection of the part, but on the quality of its surface, which must not show ripples or unwanted marks. Unlike patent BR 132019025379 E2 and U.S. Ser. No. 11/024,020 B2, which inspects painted parts using visible light reflected on the part, the present invention inspects unpainted metal surfaces using infrared radiation mirror reflected on the part. The reason for using the infrared spectrum is to exploit the different optical properties that many materials exhibit in this spectrum, most notably an increase in reflectivity on unpolished metal surfaces. In the visible spectrum, unpolished metals generally exhibit an opaque reflection that blurs the image, whereas they demonstrate an almost mirror-like reflectivity in the infrared spectrum. Glass and some plastics, which are transparent or exhibit multiple reflections in the visible spectrum, also exhibit mirror reflection. The amount of mirror reflection on a metal surface with roughness increases with increasing wavelength, which is why, although visible illumination reflects diffusely on these surfaces, infrared illumination reflects like a mirror.

A common system in geometric analysis is the three-dimensional or 3D scanner, such as the one presented in U.S. Pat. No. 6,738,507 B2, which uses a set of lasers or monochromatic lights and a series of photographs of the part to reconstruct the topology of the measured part on a computer, generating a three-dimensional point cloud. Due to the need for precision and the time it takes to capture photographs, these 3D scanner systems are used for metrology in the automotive industry, but are not suitable for use on the production line, which requires a much higher speed. The dimensional control of the parts through the 3D scanner focuses on the variation between the height measured on the part and the projected one. Height variation is not the unit most sensitive to ripple surface defects, but rather the curvature variation of the part, which is its second derivative. Even ripples with small variations in height of 30 micrometers can be visually observed by an inspector when he reflects light fringes on a part. Similar problems have for line-by-line part profile scanners, such as the one presented in U.S. Pat. No. 7,962,303 B2 and U.S. Pat. No. 5,844,801 A, bringing limitations to production line use, which requires speed of capture and processing.

Thus, through the methods and systems presented here, the following benefits are achieved: inspecting unpainted surfaces through mirror reflection in the infrared spectrum; speed of image capture and result processing compatible with the pace of industrial production; anticipate the visualization of appearance defects, for correction before painting the part; objective inspection of defects, replacement of the subjective evaluation of a human inspector and ensuring quality in the industrial process.

### BRIEF DESCRIPTION OF THE FIGURES

FIG. 1 shows the system for the automatic quality inspection of reflective materials illuminated by infrared radiation.

FIG. 2 shows a possible embodiment of the system 140 for capturing images in the infrared spectrum.

FIG. 3 shows a possible embodiment of the infrared radiation illumination system 120.

FIG. 4 illustrates possible embodiments of the infrared radiation generation system 320.

FIG. 5 illustrates possible embodiments of the system 310 used for filtering or blocking infrared radiation or protection of the system 320.

FIG. 6 illustrates a possible embodiment where the inspected part 150 is a automotive body 650, the measuring system 110 is a optical head 610 positioned with the aid of a robot 680.

FIG. 7 represents the complete flow of the materials quality inspection method.

FIG. 8 shows possible examples of images captured by the system 140.

FIG. 9 represents the architecture of a convolutional neural network.

### DETAILED DESCRIPTION

The methods and systems of this invention are illustrated in examples shown in the figures. Such examples are not mentioned to limit the scope of the claims, but to explain the methods and systems claimed through concrete examples, based on the following description of the explanatory figures and embodiments.

In one embodiment, the invention refers to a method for automatic inspection of materials that comprises the steps of:
projection of a radiation pattern in the infrared spectrum onto the material to be inspected (720);
capture of one or more images in the infrared spectrum (730);
identification, location and/or classification of material defects, based on the images captured, using artificial intelligence techniques (750).

According to this embodiment, the method can comprise the generation of radiation in the infrared spectrum by heating a material in a radiation generation system (320) in the infrared spectrum. In a preferred embodiment, the radiation pattern in the infrared spectrum projected onto the material to be inspected (720) is a light-shadow pattern, i.e., a pattern in which some regions of the inspected material are irradiated with infrared light while others are not irradiated, or receive substantially less irradiation.

Also according to a preferred embodiment, the captured image comprises the pattern of light and shadow generated by the radiation generation system in the infrared spectrum. Non-limiting examples of such patterns are given in FIG. 4.

In an optional embodiment, the method may comprise an image pre-processing step (740) captured in step (730), where pre-processing (740) comprises changes in resolution, direction, contrast shift, image cropping, application of masks, filters, and/or other image processing.

In a preferred embodiment, the identification, localization, and/or classification of defects (750) is done on the basis of the distortion they cause in the light and shadow patterns in the captured image, where the identification, localization, and/or classification of defects (750) can be implemented by multi-layered perceptrons, decision trees, convolutional neural networks, or combinations of these algorithms with identification as output, location and/or classification of distortions in the image. Alternatively, the identification, location and/or classification of defects (750) can be performed using a YOLO (You Only Look Once) convolutional neural network, a method that allows the identification of objects in real-time images.

Optionally, the method also includes a step for creating and displaying a report showing the location of the identified defects (760).

It is also possible that the method also includes a step for saving the data and images generated in the process (770). Preferably, the method can also comprise a step of extracting statistical data from the saved images.

In another embodiment, the present invention refers to a system for the execution of the method described herein. In a concrete embodiment, the system is characterized by the fact that it comprises a system for generating and projecting radiation in the infrared spectrum 320, a device for capturing images in the infrared spectrum, and a device that runs a software to process, identify, locate and/or classify defects in the inspected material. In another possible embodiment, the infrared radiation generation system generates a pattern of light and shadow, that is, a pattern in which some regions of the inspected material are irradiated with infrared light while others are not irradiated, or receive substantially lower irradiation.

In an embodiment, the system can be any device comprising an array of electromagnetic sensors capable of capturing an image in the infrared spectrum.

In another possible embodiment, the device that runs the program is a computer, a mobile device, a microprocessor, or any other device capable of processing and analyzing data.

In another possible embodiment, the radiation generation system in the infrared spectrum and the imaging device in the infrared spectrum are mechanically connected, forming an optical inspection system 610, which can be moved by various positions to capture images in various regions of the inspected material 650, maintaining the standard of distances and angles.

In one of the embodiments of the method of the invention, it refers to the automatic inspection of materials, comprising the capture of infrared images reflected in an inspected material to identify defects in the material using artificial intelligence techniques, in which the method comprises the steps of:
positioning of the material to be inspected under the system (710);
projection of an infrared radiation pattern onto the material to be inspected (720);
capture of one or more images in the infrared spectrum (730);
image pre-processing (740);
identification of material defects using artificial intelligence techniques (750);
creation and display of a report showing the location of the identified defects (760); and
saving of data and images generated in the process (770).

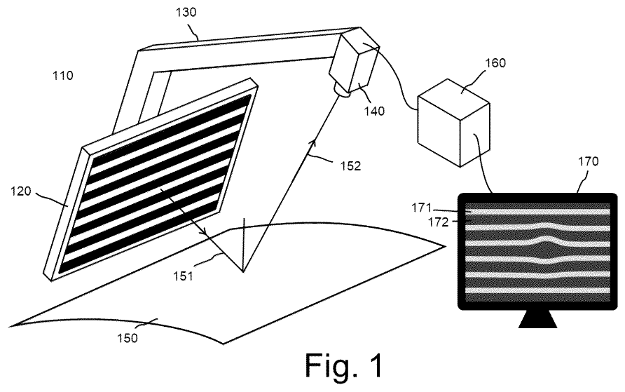

For example, FIG. 1 shows the system for the automatic quality inspection of reflective materials illuminated by infrared radiation. The incident rays 151 and the reflected rays 152 represent the infrared radiation mirror reflected on the part 150. The 110 system consists of the lighting system 120 and the capture system 140.

Preferably, for the maintenance of lighting and shooting angles and distances, the system 110 also contains a device 130, which mechanically connects the systems 120 and 140.

Infrared radiation 151 and 152 is preferentially found in the wavelength spectrum between 8 and 14 micrometers, a spectrum in which there is an increase in reflectivity on unpolished metal surfaces, glass, among others.

The capture device 140 is a system capable of capturing images in the infrared spectrum. The image capture device 140 can be, for example, a video and/or photographic camera, an infrared camera, or any array of electromagnetic sensors capable of capturing an image in the range of infrared electromagnetic waves emitted by the source 120.

The images captured by the device 140 are transmitted to a device 160, which is capable of processing the captured image, identifying and/or classifying the defects. The processor 160 can consist of one or more devices. None, part of the appliances 160 or all appliances 160 may be embedded in the system 110, if on-board processing is convenient. The apparatus 160 is a device that runs software to process, identify, and classify defects in the inspected material, for example, a computer, mobile device, microprocessor, or any other apparatus capable of processing and analyzing data.

Reports identifying defects created by appliance 160 can be displayed by appliance 170. The device 170 can be a monitor, television, screen, projector or any device capable of showing the reports and images generated in the inspection. In the example illustrated in FIG. 1, the apparatus 170 shows how the light 171 and dark 172 lines are reflected off the surface and how a defect distorts the lines in the center of the captured image, which become wavy.

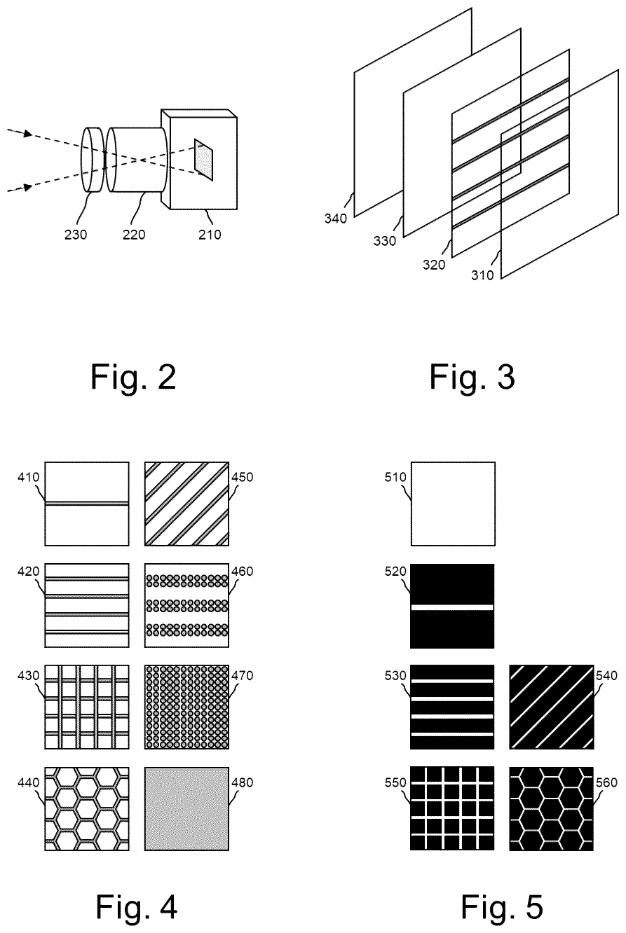

FIG. 2 shows a possible embodiment of the system 140 for capturing images in the infrared spectrum. The camera 210 with an infrared sensor and the lenses 220 are detailed. Optionally, it is also possible to use special filters 230.

FIG. 3 shows a possible embodiment of the infrared radiation illumination system 120, where the 320 infrared radiation generation system, the background radiation blocking system 330, and the cooling system 340 are detailed. At the front is the system 310, which is used for filtering or blocking infrared radiation or shielding the system 320.

The relationship between the irradiation of bodies and temperature is known as Planck's Law. Bodies radiate electromagnetic waves at various wavelengths, varying the wavelength of the radiation peak inversely proportional to their temperature. In particular, the Sun, at a temperature of approximately 6000K (Kelvin) is represented by a curve that reaches peak irradiation at the wavelength of 0.5 micrometers, which is in the spectrum of visible light. On the other hand, objects at room temperature at about 27 degrees Celsius or 300 Kelvin or heated slightly above this value have the peak irradiation at 10 micrometers, in the same infrared range as most thermal camera sensors, from 8 to 14 micrometers. This range is known as Long wave infrared, LWIR. The intensity of the total energy emitted is proportional to the fourth power of body temperature, known as the Stefan-Boltzmann Law. The body with optimal irradiation and absorption (100%) described by Planck's Law is called the black body. The irradiation constant is the ratio between the actual irradiation of a body and a black body at the same temperature.

The system should reflect a pattern of light and shadow in the infrared spectrum onto the part 150. For example, a radiating line, such as one or more light lines, surrounded by a darker system, which radiates less. Thus, the captured image will have light 171 and dark 172 lines.

There is a great set of possibilities for creating these patterns of light and shadow. A possible embodiment is a system 320 formed by a set of metallic wires, powered by electrical voltage, which heats them by Joule effect, with a thermal insulating base 330 that does not reflect thermal radiation, a cooling system 340 that allows temperature control, and a transparent protection 310 against thermal radiation radiated by system 320.

FIG. 4 illustrates possible embodiments of the infrared radiation generation system 320 and FIG. 5 illustrates possible embodiments of the system 310 used for filtering or blocking infrared radiation or shielding the system 320. The joining of the geometries of the systems 310 and 320 aims to create a pattern of light and shadow in the infrared spectrum.

Possible, non-limiting embodiments of the system 320 are a heated wire or bar 410, a set of heated wires or bars 420, a rectangular mesh 430, a hexagonal mesh 440. The direction of these elements can be diagonal as in 450, vertical, horizontal or in any angular direction. The elements can also be discrete, formed by dots such as 460 and 470, of metallic materials, semiconductors, infrared LEDs or other sources of radiation. The system can also be continuous, as in 480.

Possible, non-limiting embodiments of the system 310 are a slot 520, a set of slots 530, diagonal slots 540, rectangular mesh slots 550, hexagonal mesh slots 560. If the geometry of the system 320 already ensures the desired contrast of light and shadow, the system 310 may be unnecessary or transparent in the infrared spectrum as in 510.

The system 330 can be insulating or thermal reflector, depending on the embodiment of the systems 310 and 320. For example, the system 330 can be reflective in the case of the use of the systems 480 combined with 530.

Drawings of FIGS. 1, 2, 3, 4 and 5 do not show mechanical coupling, mechanical support, power supply and data transfer systems. It is, however, obvious to a person skilled in the art, the need for these devices in addition to the systems mentioned. The heating for the generation of thermal radiation in the system 320, for example, requires electrical energy for its operation.

A possible embodiment of the system 320 uses an electrical resistance wire of a nickel-chromium alloy, approximately 0.5 millimeters thick, heated by the electrical supply with a direct voltage of 12 Volts. Heating the wire two or three tens of degrees Celsius above room temperature is sufficient to observe the intended contrast of light and shadow in the images captured by 140.

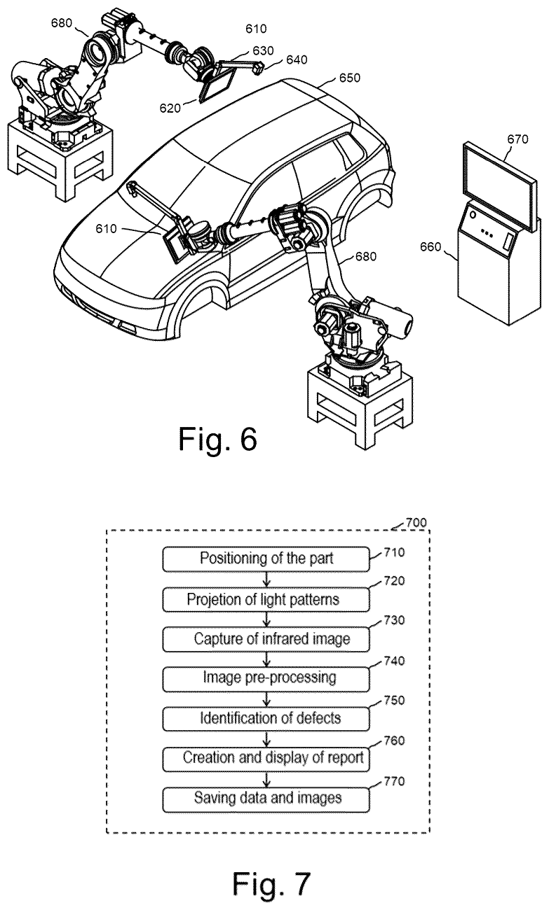

FIG. 6 illustrates a possible embodiment where the inspected part 150 is a automotive body 650, the measuring system 110 is a optical head 610 positioned with the aid of a robot 680.

The distances and measurement angles between the inspected body 650, the capture system 640 and the infrared source 620 are kept standardized with the aid of the robotic arm 680, together with the mechanical structure of the system 530, which creates a mechanical connection between 620 and 640. This standardization is necessary in order for the reflection of infrared illumination to be correctly captured by the apparatus 640 for the correct comparison and interpretation of the acquired images and to meet the optical requirements of the system, for example, to keep the inspected material 650 in focus at a position within a frame and the depth of field of the lens system of the imaging apparatus 640. If the inspected material 650 is larger in size than the capture area of the system 640, the inspection system 610 is moved to various positions in order to capture images in various regions of the inspected material 650, maintaining the standard of distances and angles with the aid of the robotic arm 680, which makes the motion trajectory compatible with this standardization. The use of one or more robotic arms 680 positioning the inspection system 610 gives the system 610 the flexibility to work to capture images of different products and geometries by programming a new trajectory for the robot 680 with each new geometry.

After processing the images, identifying and classifying the defects using the computer 660 in each of the inspected regions, the complete part inspection report is created by combining the location of the defects in the captured images in each of the regions with the location of the defects in the material as a whole, represented by their virtual design on the computer, using the reference of the position of the robotic arm 680 when the images were captured. The inspection report evidencing the defects of the part 650 is shown, for example, on one or more monitors 670, which may be in close proximity to the optical system 610, or at another location, for example, where quality information is useful for correcting defects in the inspected materials 650.

In an example of the embodiment of FIG. 6, the inspected body 650 may be an unpainted metal body, which presents diffuse reflection to visible illumination, but has specular illumination in the infrared spectrum.

In another example of FIG. 6, the inspection system 610 is used to inspect unwanted corrugations and dents with a diameter in the order of centimeters on the metal body, such as positive mark, negative mark, lift, sinking, buckling, ripple or wrinkles.

FIG. 7 represents the complete flow of the materials quality inspection method. The method refers to the automatic inspection and identification of defects in the material, using the capture of infrared images reflected in the material and the analysis of the images using artificial intelligence techniques. The method comprises the following steps: positioning of the part to be inspected under the system (710); projection of an infrared radiation pattern onto the material to be inspected (720); capture of one or more images in the infrared spectrum (730); image pre-processing (740); identification of material defects using artificial intelligence techniques (750); creation and display of a report showing the location of identified defects (760); and saving the data and images generated in the process (770).

Step 710 comprises the positioning of the system 110 on part 150 at standardized distances and angles for capturing infrared images.

Step 720 illuminates part 150 with a pattern of light and shadow, in the infrared spectrum, which is mirror reflected by part 150.

Step 730 captures the mirror reflection on part 150 in the infrared spectrum using the apparatus 140.

Step 740 performs image pre-processing, such as changes in resolution, direction, contrast shift, image cropping, masking, and/or other necessary image processing.

Step 750 performs the identification of defects using artificial intelligence techniques to locate the defects based on the distortion they cause in the light patterns in the captured image. Software can identify, locate and/or classify defects, as well as classify them automatically, through an artificial intelligence process.

In a possible embodiment, the image captured by the 140 system, part of this image or a set of these images serve as input to an artificial neural network, which has as its output the identification and location of defects in the image. Step 750 can be implemented, for example, by multi-layered perceptrons, decision trees, convolutional neural networks, or combinations of these algorithms.

In an embodiment, the synaptic weights of the artificial neural network are trained through a set of images with identified defects, that is, through a supervised training carried out in the calibration phase of the software. After training this network, it is possible to classify similar objects with regard to the identification and classification of defects in the images.

In an embodiment, the transfer learning method is used. The neural network already has a previous training carried out with another image bank and hyperparameters. Subsequently, supervised training is carried out with the set of images with identified defects.

In one embodiment, the training of the neural network is performed using a manual effort of image labeling, through the identification of rectangles on images in the location of defects. The created database associates metadata to the images, with the object class, position and size of these rectangles. To train the neural network, hundreds or thousands of labeled images are required, an effort made during the project period. With these labeled images, the neural network is optimized for defect recognition. The trained neural network is later used for the identification 750.

In a preferential embodiment, step 750 is performed using a YOLO (You Only Look Once) convolutional neural network, a method that allows the identification of objects in images in real time. This neural network is composed of dozens of layers, through which the information from the image pixels passes and is processed, using mathematical operations, some of them with synaptic weights, optimized through the training of the neural network. The layers are grouped into the parts: backbone, neck, and head.

In another embodiment, step 750 is performed using a Resnet or EfficientNet convolutional neural network.

In an embodiment, step 750 is performed in software running on a graphics processing unit (GPU), which allows the identification of objects in images in real time.

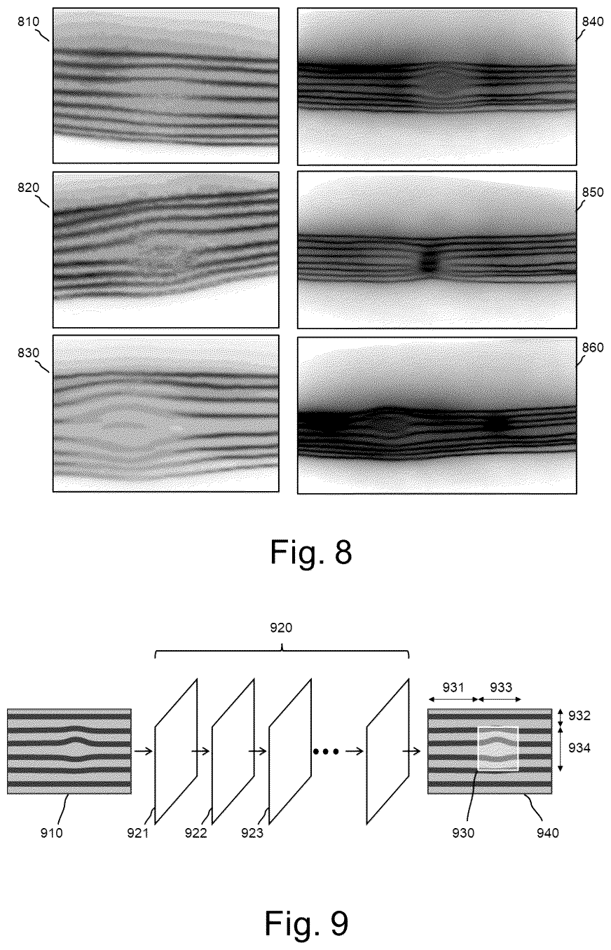

FIG. 8 shows possible examples of images captured by the system 140. The parts 150 inspected are unpainted steel metal automotive parts. In this specific example, the system 120 used contained 8 nickel-chromium wires of about 300 millimeters, electrically connected in series, arranged with a separation of 5 millimeters between them and heated by the application of a direct current by a 24V and 5A source. The wires were composed of a nickel-chromium alloy with a thickness of 0.5 millimeters and a resistance of 6.7 Ohms per meter.

The device 140 that captures the images in FIG. 8 is an infrared thermal camera with sensitivity in the wavelength range of 8 to 14 millimeters, a resolution of 382 by 288 pixels and a lens 220 with a focal length of 13 millimeters.

In the images captured, it is possible to see the contrast of light and shadow generated by the geometry of the heated wires. The darker regions are the reflection of the high emission of the heated wires. The brightest regions are the regions with the lowest infrared emission. It is also possible to see distortion in the reflected line patterns caused by distortions on the inspected surface, indicating the presence of surface defects on the unpolished metal surface. The images shown in FIG. 8 clearly illustrate the system's ability to capture images that show surface defects in unpainted metal parts.

Image 810 shows the capture of a soft defect, 820 shows the capture of a medium defect, and 830 shows the capture of a severe defect. The greater the severity of the defect, the more it distorts the reflected lines.

FIG. 9 represents the architecture of a YOLO convolutional neural network used for identification 750. The neural network 920 receives an image 910 as input and returns as output the location of the identified defects 930. The neural network is made up of dozens of mathematical processing layers 921, 922, 923. In its output, the location of the defect is shown by its row 931 and column 932, its width 933 and height 934, forming a rectangle known as the bounding box.

None, one, or multiple bounding boxes can be presented as output from the neural network 920, depending on the number of defects found. Each bounding box is assigned by the neural network a probability of that defect being found to belong to a class of defects. The neural network can be trained to identify defects of a single class or multiple classes, and can present as outputs bounding boxes indicative of one or more classes of defects.

What is claimed is:

1. Method for automatic inspection of materials comprising the steps of:
projection of a radiation pattern in the infrared spectrum onto the material to be inspected;
capture of one or more images in the infrared spectrum;
identification, location and/or classification of material defects, based on the images captured, using artificial intelligence techniques.

2. Method, according to claim 1, comprising the generation of a radiation in the infrared spectrum by heating a material in a radiation generation system in the infrared spectrum.

3. Method, according to claim 1, wherein the radiation pattern in the infrared spectrum projected onto the material to be inspected is a pattern of light and shadow.

4. Method, according to claim 3, wherein the captured image comprises the pattern of light and shadow generated by the radiation generation system in the infrared spectrum.

5. Method, according to claim 1, comprising an image pre-processing step captured in the capture step.

6. Method, according to claim 5, wherein the pre-processing stage comprises changes in resolution, direction, contrast shift, image cropping, application of masks, filters and/or other image processing.

7. Method, according to claim 1, wherein the identification, location and/or classification of defects is done on the basis of the distortion they cause in the light and shadow patterns in the captured image.

8. Method, according to claim 7, wherein the identification, localization, and/or classification of defects can be implemented by multi-layered perceptrons, decision trees, convolutional neural networks, or combinations of these algorithms with the identification, localization, and/or classification of distortions in the image.

9. Method, according to claim 8, wherein the identification, location and/or classification of defects is performed using a YOLO (You Only Look Once) convolutional neural network, a method that allows the identification of objects in images in real time.

10. Method, according to claim 1, also comprising a step of creation and display of a report showing the location of the identified defects.

11. Method, according to claim 1, also including a step of saving the data and images generated in the process.

12. Method, according to claim 11, also including the extraction of statistical data from the saved images.

13. System for the execution of the method described in claim 1, the system comprising a system for generating and projecting radiation in the infrared spectrum, a device for capturing images in the infrared spectrum, and a device that runs software to process, identify, locate and/or classify defects in the inspected material.

14. System, according to claim 8, wherein the system of generating infrared radiation generates a pattern of light and shadow.

15. System, according to claim 8, wherein the image capture device is any device comprising an array of electromagnetic sensors capable of capturing an image in the infrared spectrum.

16. System, according to claim 8, wherein the device running the program is a computer, a mobile device, a microprocessor, or any other device capable of processing and analyzing data.

17. System, according to claim 8, wherein the radiation generation system in the infrared spectrum and the imaging device in the infrared spectrum are mechanically connected, forming a optical inspection system.

18. System, according to claim 12, wherein the optical inspection system is moved by various positions so as to capture images in various regions of the inspected material while maintaining the standard distances and angles.
